(19) United States
(12) Patent Application Publication
(10) Pub. No.: US 2005/0235530 A1
(43) Pub. Date: Oct. 27, 2005

(54) Display card with removable content

(76) Inventor: Pierre Boisvert, Boisbriand (CA)

Correspondence Address: INVENTARIUM;Suite 1607, 4050 Rosemont Blvd, Montreal, H1X 1M4, CA

(21) Appl. No.: 11/104,778

(22) Filed: Apr. 13, 2005

Related U.S. Application Data
(60) Provisional application No. 60/565,075, filed on Apr. 26, 2004.

(51) Int. Cl. G06F 1/16

(52) U.S. Cl. 40/124.06

(57) ABSTRACT

A display card with removable content has a transparent film layer having a face covered with an adhesive substance. The transparent film layer adheres to a first transparent self-adhering laminate layer, and this first transparent self-adhering laminate layer, in turn, adheres to a first face of a printed layer. This printed layer has a second face which adheres to a second laminate self-adhering layer, and, adhering onto the transparent film layer is the bottom part of a capsule wherein the capsule has a removable top part for accessing the contents of the capsule.

This application claims priority based on provisional Patent No. 60/565,075 filed Apr. 26, 2004

### BACKGROUND OF THE INVENTION

1. Field of the Invention

The invention relates generally to display packaging and particularly to a display card having removable display content.

2. Background of the Invention

Collectors have a need for containers that have the ability to protect as well as show the content within. For small collectibles such as coin, stamp, medal, stone or organic materials such as insect, petal, feather, bone, tooth, skin, blood, etc. . . . there exist small display cards having a capsule containing the collectible.

A more thorough discussion of the prior art can be found in this inventor's own prior U.S. Pat. No. 6,128,840 which is incorporated herein by reference and which discloses a display card which has a ring of adhesive material binding a display object on the display card. Once assembled, the display content cannot be removed unless damaging the display card and potentially its display content as well.

### SUMMARY OF THE INVENTION

In view of the foregoing disadvantage inherent in the known devices now present in the prior art, the present invention, which will be described subsequently in greater detail, is to provide the object and advantage which is to have a display card containing a capsule with a removable top part so that the contents of the capsule can be accessed for physical handling.

To attain these ends, the present invention generally comprises a display card having a series of 4 layers plus a two part transparent capsule having a bottom part and a top part. The top part acts like a removable cap while the bottom part holds the content and is bond to the display card.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

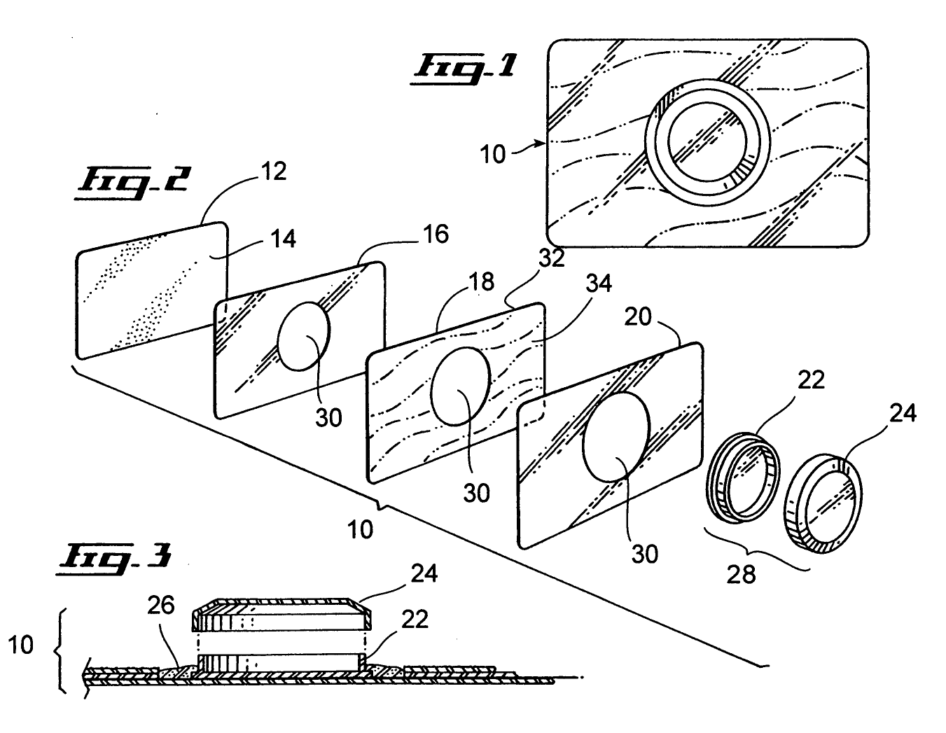

FIG. 1 Front elevation of the display card.

FIG. 2 Exploded perspective showing the individual parts.

FIG. 3 Side cutaway elevatuin showing a slice of the individual parts.

### DETAILED DESCRIPTION OF THE PREFERRED EMBODIMENT

A display card (10) for displaying objects has a transparent film layer (12) having a face covered with an adhesive substance (14). This transparent film layer adheres to a first transparent self-adhering laminate layer (16) which adheres to a first face (32) of a printed layer (18) printed on both faces. The printed layer's (18) second face (34) is adhering to a second laminate self-adhering layer (20). Adhering onto the film layer (12) is a bottom capsule part (22) part of a capsule (28) and frictionally engaging the bottom capsule part (22) is a top capsule part (24). A resinous substance (26) reinforces the bonding between the bottom capsule part (22) and the film layer (12). A display aperture (30) is present in the first laminate layer (16), the printed layer (18), and the second laminate layer (20) and allows passage of the capsule (28). Besides frictional engagement, both parts of the capsule (28) can be engaging in various ways well known in the art such as threading engagement or any known variations thereof.

An object inserted within the capsule (28) has both its faces visible as well as its peripheral edges visible. It can also be removed from the capsule (28) for closer examination and direct physical contact.

The display aperture (30) is sligtly larger than the size of the capsule (28) to allow room for the resinous substance (26).

The manufacturing method is similar to that of this inventor's own prior invention now U.S. Pat. No. 6,128,840 as previously discussed but with the essential difference that instead of mounting the display object within the display aperture (30) and bonding it to the transparent film layer (12), the capsule (28) is inserted and there is no need for a second protective layer as in the prior art since the capsule (28) itself, more particularly the top capsule part (24), is the second protective layer of the prior art.

As to the current art, the same substances and material described in this inventor's own prior art still apply since at this point in time, they offer the best properties concerning resistance to oxidation, ultraviolet radiation, heat, and other environmental factors.

This new dispaly card offers an advantage which could not have been anticipated based on the manufacturing method as described in the prior art be it from this instant inventor's prior art or from all other related prior art.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A display card for displaying objects comprising:
a transparent film layer having a face covered with an adhesive substance;
said transparent film layer adhering to a first transparent self-adhering laminate layer;
said first transparent self-adhering laminate layer adhering to a first face of a printed layer printed on both faces;
a second self-adhering laminate layer adhering to a second face of said printed layer;
adhering onto said film layer is a bottom capsule part;
frictionally engaging said bottom capsule part is a top capsule part;
said bottom capsule part and said top capsule part forming a capsule;
resinous substance to reinforce bonding between said bottom capsule part, and said film layer;
a display aperture on said first laminate layer, said printed layer, and said second laminate layer to allow passage of said capsule.

2. A method of manufacturing a display card comprising the steps of having a transparent film layer having a face covered with an adhesive substance; said transparent film layer adhering to a first transparent self-adhering laminate layer; and
said first transparent self-adhering laminate layer adhering to a first face of a printed layer; and said printed layer having a second face; said second face from said printed layer adhering to a second laminate self-adhering layer; and having the following improvement in manufacturing steps:
adhering onto said transparent film layer is a capsule, bottom part.
